(19) United States
(12) Patent Application Publication
(10) Pub. No.: US 2014/0002406 A1
(43) Pub. Date: Jan. 2, 2014

(54) Low-Power Capacitive Sensor Monitoring and Method

(71) Applicants: Ronald F. Cormier, JR., Vail, AZ (US); Michael D. Snedeker, Tucson, AZ (US)

(72) Inventors: Ronald F. Cormier, JR., Vail, AZ (US); Michael D. Snedeker, Tucson, AZ (US)

(73) Assignee: TEXAS INSTRUMENTS INCORPORATED, Dallas, TX (US)

(21) Appl. No.: 13/535,789

(22) Filed: Jun. 28, 2012

(51) Int. Cl. G06F 3/044

(52) U.S. Cl. 345/174

(57) ABSTRACT

A touch screen controller produces a first signal (DATA) representative of a self capacitance (Cselfj) of a touch screen (13A) during a presence scanning mode and representative of mutual capacitances (Cmij) of the screen during a location scanning mode. The first signal is calibrated during the presence scanning and during the location scanning to produce a second signal (ΔDATA) which may represent either self-capacitance changes (ΔCselfj) caused by proximity of an element (22) during presence scanning or mutual capacitance changes (ΔCmij) caused the element during location scanning. The second signal is operated upon during presence scanning to determine to determine proximity of the element relative to the screen and during location scanning to produce a magnitude map of the mutual capacitance changes.

### BACKGROUND OF THE INVENTION

The present invention relates generally to capacitive sensor touch screen panels, and more particularly to improved control circuitry and techniques for determining the presence or absence of a touch on a touch screen panel faster and with less power than prior control circuitry for capacitive sensor touch screen panels.

The closest prior art is believed to include commonly assigned, published, and allowed pending US patent application entitled “De-convolution-based Capacitive Touch Detection Circuit and Method” by Cormier, Jr. et al., application Ser. No. 12/587,453, filed Oct. 7, 2009, published Sep. 30, 2010, Publication No. 2010/0244859 (hereinafter, “the '859 application”), which is entirely incorporated herein by reference. The foregoing application describes use of a “3q” scanning technique wherein scanning of each “node” of a touch screen panel involves transfer of 3 charge packets to achieve a linear combining of charges, referred to herein as a “convolution”. In the “3q” charge transfer scanning technique, the “capacitor of interest” provides 3 charge packets and is convenient for describing the matrix mathematics described in the '859 application. All of the charge packet transfers from each row conductor are transferred to each column conductor. The resulting “convoluted” or combined signals are entered into a matrix as values of all of the row-to-column “mutual capacitances”, including the effects of a finger touch on the touch screen panel upon the mutual capacitance values. Matrix mathematics is utilized to “de-convolute” or recover the convoluted or combined signal values in order to determine the peak mutual capacitances and locations thereof in the touch screen panel, and thereby determine the precise location of the finger touch.

The relevant prior art also includes commonly assigned U.S. Pat. No. 7,982,471 entitled “Capacitance Measurement System and Method” and issued Jul. 19, 2011 to Mueck et al., and commonly assigned U.S. Pat. No. 8,018,238 entitled “Embedded SAR Based Active Gain Capacitance Measurement System and Method” and issued Sep. 13, 2011 to Cormier, Jr.

Prior Art FIG. 1 is essentially the same as FIG. 3A of above-mentioned incorporated-by-reference Patent Application Pub. No. 210/0244859, and shows a touch screen controller system 36 which may include an analog/digital or “Analog Engine” circuit 15 generally as shown in FIG. 2. The same or similar reference numerals are used to designate the same or similar parts in both Prior Art FIG. 1 herein and FIG. 3A of the '859 published application.

Prior Art FIG. 2 herein is generally similar to FIG. 4 in the '859 application and is useful in understanding the above mentioned “3q” charge transfer/convolution idea; the same or similar reference numerals are used to designate the same or similar parts in both Prior Art FIG. 2 herein and FIGS. 4 and 5 in the '859 application. Prior Art FIG. 2 shows a configuration of row drive circuitry 45 which includes 10 row driver circuits 45-0, 1, 2 . . . 9, the outputs of which are connected by a corresponding row conductor 2i (where 0≦i≦9), respectively, to a first or left terminal of each of 10 corresponding mutual capacitances Cmij for each column 3j where 0≦j≦5. (Note that the mutual capacitances Cmij herein correspond to the mutual capacitances C_{SENij} referred to in the incorporated-by-reference '859 application. The terms Cmi and Cmij herein both refer to the same mutual capacitances between a row conductor 2i and a column conductor 3j.) The second terminal of each mutual capacitance Cm_{0, 1 . . . 9} is connected to a single column conductor 3j (0≦j≦5).

Stated somewhat differently, the mutual capacitances Cm_{0, 1 . . . 9} are the cross-coupling capacitances between the various row conductors 2i and the various column conductors 3j. The self capacitance Cselfj of a column conductor 3j is its total parasitic capacitance to ground (and/or other reference).

Each row conductor 2i in the example of FIG. 2 is coupled to the right terminals of a corresponding P-controlled switch that is closed only during the precharge phase P and a corresponding M-controlled switch that is only closed during the measurement phase M. In this example, for the purpose of an initial driving or “energizing” of the 10 row conductors 2i, only mutual capacitance Cm₀ is considered to be a “capacitance of interest”, and the left terminal of its corresponding P-controlled switch is connected to V_{DD} and the second terminal of its corresponding M-controlled switch is connected to ground. (As “full panel scanning” of touch screen panel 13A occurs, each of the remaining mutual capacitances Cm_{0, 1 . . . 9}, one at a time, becomes the present “capacitance of interest”.)

The first terminal of mutual capacitance of interest Cm₀ is coupled by its corresponding P-controlled switch to V_{DD} and is also coupled by its corresponding M-controlled switch to ground. However, the first terminal of mutual capacitance Cm₁ is coupled by its corresponding P-controlled switch to ground and is also coupled by its corresponding M-controlled switch to V_{DD}. The first terminal of each mutual capacitance Cmᵢ other than Cm₀ (if Cm₀ is the capacitor of interest) is coupled by its corresponding P-controlled switch to ground and is also coupled by its corresponding M-controlled switch to ground. In order to accomplish the “3q” charge transfer technique described in the '859 published application so as to accomplish the described “convolution” or combining of the output signals produced by analog engine 15, the same general pattern of connection is repeated for mutual capacitances Cm_{1, 2 . . . 9}.

Column conductor 3j in Prior Art FIG. 2 is coupled to ground by P-controlled switch Sj, and column conductor 3j also is coupled by M-controlled switch S2 to the (−) input of amplifier 31. The (+) input of amplifier 31 in FIG. 2 herein is coupled to a suitable reference voltage, which can be equal to V_{DD}/2. The output conductor 20 of amplifier 31 is coupled by P-controlled switch S9 to the (−) input of amplifier 31 and by multiple M-controlled switches Sk to corresponding bottom plate conductors 21 of CDAC 23 as shown in FIG. 2A of the '859 application, and the (−) input of amplifier 31 also is connected to top plate conductor 24 of CDAC 23 as shown in FIG. 2A of the '859 application. The output 20 of amplifier 31 is coupled to the input of ADC 17, which can be implemented by means of the SAR ADC generally as indicated in FIG. 2 of the '859 application and above mentioned commonly assigned U.S. Pat. Nos. 7,982,471 and 8,018,238. The SAR ADC 17 may be, but is not necessarily, included in the same chip as the remaining circuitry shown in FIG. 1.

In operation of the circuitry shown in FIG. 2, each of the 10 row conductors 2i is driven individually, generally in the manner indicated, such that during the precharge phase P illustrated in Prior Art FIG. 3 the “capacitance of interest”, for example Cm₀, is charged and sampled so as to transfer an amount 3q of charge to column conductor 3j, and the remaining 9 alternate mutual capacitances are charged and sampled so as to transfer charge amounts of +q and −q, respectively, to column conductor 3j.

During the measurement phase M illustrated in Prior Art FIG. 4, charge from all 10 of the mutual capacitances Cm_{0, 1 . . . 9} is transferred to the single column conductor 3j, thereby linearly superimposing or convoluting or combining all of the transferred charge from mutual capacitances Cm_{0, 1 . . . 9} onto the single column conductor 3j.

The foregoing operation then is repeated for the case in which the next mutual capacitance Cm₁ becomes the capacitance of interest, and so on until the procedure has been performed on all of capacitances Cm_{0, 1 . . . 9}. During the course of a complete scan of a particular column 3j, each of the 10 mutual capacitances Cm_{0, 1 . . . 9}, one at a time, becomes the present “capacitance of interest”.

More details of one implementation of analog engine circuit 15 in Prior Art FIG. 1 are shown in FIGS. 2A-2D of the '859 application, wherein engine 15 in Prior Art FIG. 1 is operated so as to accomplish a “convolution” or combining of all of the mutual capacitances C_{SENij}, which instead are referred to herein as “mutual capacitances Cmij, between all of the rows 2i (where, for example, 0≦i≦9) and any particular column 3i (where, for example, 0≦j≦5) of touch screen panel 13A into a column signal generated on a corresponding column conductor 3j. The convolution is accomplished by means of the “3q” charge packet transfer procedure described in conjunction with FIGS. 4 and 5 of the '859 application. A change ΔCmij in the mutual capacitance between a row conductor 2i and a column conductor 3j of touch screen panel 13A is caused by the presence of a finger touch (or suitable conductive stylus, etc.) on or very close to that mutual capacitance. The resulting column signal is digitally “de-convoluted” by means of a de-convolution algorithm performed in block 44 of Prior Art FIG. 1 to obtain a signal representing an amount of charge transferred from a particular one of the mutual capacitances Cmij to the column conductor 3j. In the example of Prior Art FIG. 1, a 10 row by 6 column implementation of touch screen panel 13A is shown. (FIG. 5 in the '859 application indicates the concept of a linear system where each charge packet transfer provides a linear contribution to the total column conductor output voltage.) The row conductors 2i (where 0≦i≦9) and column conductors 3j (where 0≦j≦5) are connected to an input of analog engine 15. Control signals for analog engine 15 are produced on bus 37-1 by a digital control circuit 38.

The matrix equation shown in Prior Art FIG. 1 represents a process by which convoluted digital data D is generated within analog engine 15. Dashed line 33 encircles the system components that produce the convoluted digital data D and from it produce de-convoluted data which is utilized to determine the location of the present touch on panel 13A.

The inverse matrix A⁻¹ of the matrix illustrated in Prior Art FIG. 1 is multiplied by the matrix C_{S}−ΔC to produce the values of each of the mutual capacitances of the entire described 10 row by 6 column touch screen panel. The output signal D (DATA) produced on digital bus 32 in FIG. 1 by analog engine 15 is applied to the (+) input of a digital summer 40. The output signal D on bus 32 may be represented by the matrix expression

$$k [ A \times ( {C}_{S} - Δ C ) + {C}_{par} + \frac{1}{2} {\sum }_{j = 0}^{9} Δ {C}_{j} ] = D ,$$

where A is the square left matrix in Prior Art FIG. 1, C_{S} is a matrix or vector including mutual capacitances Cm0, 1 . . . 9, ΔC is an unknown quantity to be solved for, Cₚₐᵣ is a constant parasitic capacitance, and k is equal to 4096/2C_{DAC}, where C_{DAC} is the capacitance of CDAC 23 in FIG. 2A of the '859 application.

To determine where a touch has occurred on panel 13A, the signal D on bus 32 must first be “calibrated” by taking a measurement of each mutual capacitance node on a column. This initial data stream is represented by the equation

k[A×C_{S}+Cₚₐᵣ+0]=D_{Cal}.

Subsequent values of data, which are produced at the output of algebraic summer 40, are compared to this baseline to obtain ΔCmij values, or “delta” values. These values are represented by the equation

$$k [ - A \times Δ C + \frac{1}{2} {\sum }_{j = 0}^{9} Δ {C}_{j} ] = D - {D}_{Cal} .$$

It should be noted that the term “½” in the foregoing expression is a function of the particular panel being analyzed. The present analysis assumes that when a touch occurs, ½ of the AC charge is shunted to the “row side”, while the other ½ of the AC charge is shunted to the “column side”. However, in a different panel the term “½” could be replaced by a different fractional value. The largest delta value obtained from a full scan of touch panel 13A represents the “strongest” touch, the location of which is determined as subsequently explained. The “baseline” or neutral values for all mutual capacitances Cmij obtained from the initial scan of touch panel 13A with no finger touches thereon are stored in calibration memory 39.

The output 41 of calibration memory 39 is applied to the (−) inputs of summer 40, the (+) inputs of which receive the convoluted raw data signal D on bus 32. During normal operation, the baseline data values stored in calibration memory 40 are subtracted from corresponding present values of data output D by analog engine 15 by means of digital algebraic summer 40 to generate the “calibrated” data stream ΔD (i.e., ΔDATA) representing changes ΔCmij of any mutual capacitance influenced by the presence of a finger. (Thus, during normal operation, if no finger touches are present on panel 13A, the output of digital summer 40 consists of all “0”s.) The raw data generated by analog engine 15 is always stored in calibration memory 39 and the calibration methodology for accomplishing this is described in the '859 application.

The calibrated output data stream ΔD of algebraic summer 40 is represented by the expression

D−D_{Cal}=k[(−A+S)×ΔC],

where D_{Cal} represents the “non-touch” raw data panel values, and is stored in an array in calibration RAM 39 (which is a 10×6 in the above example) and is subtracted from the data D obtained by scanning touch screen panel 13A, so that a non-touch condition for any node or mutual capacitance is representative of a zero value of the corresponding data at the output of summer 40, such that a touch condition at that mutual capacitance node is represented by a non-zero value. The absence of any touch is indicated by zero values on all mutual capacitance nodes.

The data stream produced on bus 32A is applied to the input of column data “de-convolution”circuit 44. De-convolution circuit 44 is controlled by signals produced on bus 37-3 by digital control circuit 38. The digital output of de-convolution circuit 44 is produced on digital bus 58, and can be represented by the expression

k[ΔC]=J⁻¹(D−D_{Cal}).

This signal on bus 58 is applied to the input of a touch detection circuit 50 which is controlled by signals produced on bus 37-4 by digital control circuit 38. The “touch location” data produced by touch detection circuit 50 is applied by means of digital bus 51 to the input of a suitable digital interface circuit 53 (which, for example, can be a conventional I²C interface circuit that produces a corresponding output signal on bus 55).

The resulting digital output data stream D produced by SAR ADC 17 in FIG. 2 is calibrated by subtracting the baseline values from it in order to generate ΔD as a stream of values of Cmij which are used to identify the precise location of a present finger touch on panel 13A. The “convolution” or combining introduced by the superposition of all of the touch screen panel row voltages onto any particular column conductor 3j then is “de-convoluted” by means of the de-convolution process which is associated with block 44 in FIG. 1 (and which is described in the '859 application).

The data generated by analog engine 15 represents a “data map” or panel topology map containing convoluted touch location data, one measurement at a time, for the entire touch panel 13A. The digital logic, which includes a finite state machine and/or a CPU in digital control circuit 38, arranges the successive data values in the desired order. That convoluted data map becomes de-convoluted by processing the data through de-convolution circuit 44. The de-convoluted data map can then be used to find the locations of the magnitude peaks and/or valleys.

The output generated on digital bus 58 by de-convolution block 44 in accordance with the de-convolution algorithm in block 44 (also see FIG. 7 of the '859) application represents a “magnitude map” of mutual capacitances of touch screen panel 13A indicating any present finger touches thereon. The three-dimensional diagram illustrates a peak “A”, as shown in FIG. 3B of the '859 published application, in the magnitude map for a normal finger touch on panel 13A directly over a corresponding mutual capacitance Cmij, which is also referred to herein as a “node” of panel 13A.

Touch detection circuit 50 in FIG. 2 performs a touch detection algorithm (described with reference to FIG. 8 in the '859 application) which searches the magnitude map for the largest magnitude peaks, over which the largest peak values of ΔCmij occur when a touch is located directly over a mutual capacitance Cmij of touch screen panel 13A. As the finger touch moves away from this node, the magnitude of the corresponding peak will decrease and the magnitudes on other nodes will increase.

The left-hand matrix shown above analog engine 15 in FIG. 1 stores the results of transferring the above mentioned 3q packets +q, −q, and 3q to provide the convoluted signals on the column conductors 3j.

The matrix calculations in the foregoing example are based on scanning the voltages of the column conductors 3j. Scanning of the entire panel touch screen therefore requires a total of 60 such measurements and corresponding matrix computations in order to obtain the present panel map. This consumes substantially more power than would be desirable in most battery-powered applications, such as cell phone applications.

Thus, in the 10 row by 6 column example of FIG. 1, a full panel scanning operation, touchscreen controller system 36 of Prior Art FIG. 1 processes each of the 60 mutual capacitances, 10 rows and one column at a time, adjusted according to the values in calibration memory 39. Then the panel information will be processed through de-convolution block 44. If the previously mentioned “3q” method is used to drive analog engine 15, then the DC component (which is due to a change in column self capacitance) must be removed from the data after de-convolution. This is accomplished by processing data for a complete column after it has been processed by the de-convolution module. The column data will be searched for the largest value, which will then be subtracted from all other values within the column. This “normalizes” the values in the column to zero. The DC component then will be removed from the data, and the panel memory (see FIG. 3D of the '859 application) is searched for peaks. (The DC component referred to is equal to the subtracted largest value.) The four largest peaks (or any other suitable number of peaks) then are processed by means of touch detection circuit 50 and the associated touch location determining algorithm shown in FIG. 8 of the '859 published application.

It should be appreciated that most of the time the touch screen of a cell phone, electronic notepad, or the like is not actually being touched. A capacitive touch screen panel in a low-power mode must recognize the presence of a touch by scanning the touch screen panel frequently, which typically involves “waking up” the touch screen controller system 36, scanning the touch screen panel 13A, and determining if a touch is present. If so, the system goes into a high power mode, and if not, the system goes into a low-power sleep mode, in which the system nevertheless dissipates a significant amount of power. There is no practical way of determining if a touch is occurring except to detect its presence by frequently performing a full touch screen panel scan. The high amount of associated power consumption required for such frequent full panel scanning merely to determine if a touch is present is very undesirable. To summarize, the location of a touch on a capacitive touch screen panel is determined by measuring the mutual capacitance between each row conductor and each column conductor, and the capacitive touch screen sensors must be continually scanned to determine if there is a present touch on touchscreen panel 13A, and for the example of a 10 row by 6 column touch screen panel, this requires measuring 60 mutual capacitances (and in a larger touch screen panel, even more mutual capacitances must be measured) just to determine if a touch is present.

Thus, there is an unmet need for a touch screen controller which requires substantially less power consumption to detect presence of a touch on a touch screen panel than is required by the prior art.

There also is an unmet need for a touch screen controller which can detect the presence of a touch on a touch screen panel substantially faster than the prior art and which also requires substantially less power consumption to detect presence of the touch than the prior art.

There also is an unmet need for a touch screen controller which can detect the presence of a touch on a touch screen panel substantially faster than the prior art and which also requires substantially less power consumption to detect presence of the touch, and which nevertheless requires less complex hardware and software than the prior art.

There also is an unmet need for a touch screen controller which substantially more sensitive to the presence of a touch on a touch screen panel then the prior art.

There also is an unmet need for a practical, low-power way to detect large objects (such as the palm of a user's hand or a cheek of a cell phone user) that are touching or are very close to the touch screen.

### SUMMARY OF THE INVENTION

It is an object of the invention to provide a touch screen controller which requires substantially less power consumption to detect presence of a touch on a touch screen panel than is required by the prior art.

It is another object of the invention to provide a touch screen controller which can detect the presence of a touch on a touch screen panel substantially faster than the prior art and which also requires substantially less power consumption to detect presence of the touch than the prior art.

It is another object of the invention to provide a touch screen controller which can detect the presence of a touch on a touch screen panel substantially faster than the prior art and which also requires substantially less power consumption to detect presence of the touch, and which nevertheless requires less complex hardware and software than the prior art.

It is another object of the invention to provide a touch screen controller which substantially more sensitive to the presence of a touch on a touch screen panel then the prior art.

It is another object of the invention to provide a practical, low-power way to detect large objects (such as the palm of a user's hand or a cheek of a cell phone user) that are touching or are very close to the touch screen.

Briefly described, and in accordance with one embodiment, the present invention provides a touch screen controller that produces a first signal (DATA) representative of a self capacitance (Cselfj) of a touch screen (13A) during a “presence scanning mode” and is also representative of mutual capacitances (Cmij) of the screen (13A) during a “touch location scanning mode”. The first signal (DATA) is calibrated both during the presence scanning and during the location scanning to produce a second signal (ΔDATA) which may represent either self-capacitance changes (ΔCselfj) caused by proximity of an element (22) during presence scanning or mutual capacitance changes (ΔCmij) caused the element during location scanning. The second signal (ΔDATA) is operated upon during presence scanning to determine to determine proximity of the element (22) relative to the screen, and also is operated upon during location scanning to produce a magnitude map of the mutual capacitance changes.

In one embodiment, the invention provides a touch screen controller system (36-1) for controlling a touch screen (13A) having a first number (i) of first type conductors (2i) and a second number (j) of second type conductors (3j), including analog-digital circuitry (15) coupled to the first type conductors (2i) and the second type conductors (3i) of a touch screen (13A) for producing a first digital signal (DATA) representative of a self capacitance (Cselfj) of one of the second type conductors (3j) during an element proximity scanning mode and also representative of mutual capacitances (Cmij) of the touch screen (13A) during an element location scanning mode. The analog-digital circuitry (15) operates to superimpose charge transfers (e.g., using a 3q technique or 2q technique) from mutual capacitances (Cmij) of one of the first type conductors (2i) to one of the second type conductors (3i) during the element location scanning mode. The analog-digital circuitry (15) also operates to produce information representative of the influence of an element (22) on the self-capacitance (Cselfj) during the element proximity scanning mode. Calibration circuitry (39,40) is coupled to receive the first digital signal (DATA) and operates to calibrate the first digital signal (DATA) with respect to base line data representing neutral values of the self capacitances (Cselfj) during the element proximity scanning mode and to also calibrate the first digital signal (DATA) with respect to base line data representing neutral values of the mutual capacitances (Cmij) during the element location scanning mode in order to produce a second digital signal (ΔDATA) which may represent either element proximity induced self-capacitance change values (ΔCselfj) during the element proximity scanning mode or element location induced mutual capacitance change values (ΔCmij) during the element location scanning mode. Touch presence monitoring circuitry (80) operates on the second digital signal (ΔDATA) during the element proximity scanning mode to determine if the element (22) is proximate to the touch screen (13A). A processing circuit (44) operates on the second digital signal (ΔDATA) during the element location scanning mode to produce a third digital signal (58) which represents a magnitude map of element location induced mutual capacitance change values (ΔCmij).

In one embodiment, the first type conductors (2i) are row conductors and the second type conductors (3j) are column conductors.

In one embodiment, the touch presence monitoring circuitry (80) operates to continue the element proximity scanning mode by causing the analog-digital circuitry (15) to repeatedly energize an individual row conductor (2i) to cause the analog-digital circuitry (15) to generate values of the second digital signal (ΔDATA) which represent a change in the self capacitance (Cselfj) of any column conductor (3j) that is less than a predetermined touch threshold value.

In one embodiment, the touch presence monitoring circuitry (80) operates to switch operation of the analog-digital circuitry (15) to the element location scanning mode if the change (ΔCselfj) in the self capacitance of any column conductor (3j) exceeds a predetermined touch threshold value.

In one embodiment, the element location scanning mode is a full touch screen scanning mode. In one embodiment, the element (22) is a human finger touching a surface of the touch screen (13A). In one embodiment, the element (22) is a human body part located proximate to a surface of the touch screen (13A).

In one embodiment, the calibration circuitry (39,40) includes a calibration memory (39) for storing the base line data and an algebraic summer (40) for subtracting the base line data from the first digital signal (DATA). In one embodiment, the analog-digital circuitry (15) includes an analog-to-digital converter (17) which generates the first digital signal (DATA).

In one embodiment, a touch detection circuit (50) is coupled to receive the third digital signal (58) and operates to repeatedly detect and store updated values of a first maximum magnitude capacitance variable and associated row and column locations to determine the location of a maximum magnitude mutual capacitance change (ΔCmij) caused by a present touch on the touch screen (13A).

In one embodiment, during the element location scanning mode the analog-digital circuitry (15) causes the first digital signal (DATA) to be a convoluted signal which is a function of the mutual capacitances (Cmij) of at least a plurality of the row conductors (2i).

In one embodiment, the processing circuit (44) includes a de-convolution circuit (44) which operates on the second digital signal (DATA) by solving a plurality of equations that represent the mutual capacitances as functions of the amounts and polarities of charge transferred to a first column conductor (3j) and corresponding voltage components produced on the first column conductor in order to produce the third digital signal (58). The de-convolution circuit (44) stores an inverse matrix (J⁻¹) representing coefficients of a plurality of equations that represent the mutual capacitances (Cmij) as functions of the amounts and polarities of charge transferred to the first column conductor (3j) and the corresponding voltage components produced on the first column conductor, and multiplies the inverse matrix (J⁻¹) by a vector matrix representing values of the second digital data signal (ΔDATA) obtained for each of the mutual capacitances (Cmij) to obtain the values of the third digital signal (58) representing the magnitude map of the touch capacitance change values (ΔCmij).

In one embodiment, the analog-digital circuitry (15) operates to superimpose charge transfers from mutual capacitances (Cmij) of at least the plurality of the row conductors (2i) to a second column conductor to cause a corresponding portion of the first digital signal (DATA) to be a convoluted signal which is a function of the mutual capacitances (Cmij) of at least the plurality of row conductors (2i).

In one embodiment, the invention provides method for operating a touchscreen controller (36-1), including producing a first digital signal (DATA) representative of a self capacitance (Cselfj) of a second type conductor (2j) of a touch screen (13A) during an element proximity scanning mode and also representative of mutual capacitances (Cmij) of the touch screen (13A) during an element location scanning mode; calibrating the first digital signal (DATA) with respect to base line data representing neutral values of the self capacitances (Cselfj) during the element proximity scanning mode and also calibrating the first digital signal (DATA) with respect to base line data representing neutral values of the mutual capacitances (Cmij) during the element location scanning mode so as to produce a second digital signal (ΔDATA) which may represent either element proximity induced self-capacitance change values (ΔCselfj) during the element proximity scanning mode or element location induced mutual capacitance change values (ΔCmij) during the element location scanning mode; operating on the second digital signal (ΔDATA) during the element proximity scanning mode to determine proximity of the element (22) relative to the touch screen (13A); and operating on the second digital signal (ΔDATA) during the element location scanning mode to produce a third digital signal (58) which represents a magnitude map of the element location induced mutual capacitance change values (ΔCmij).

In one embodiment, the method includes continuing to operate in the element proximity scanning mode by causing analog-digital circuitry (15) to repeatedly energize an individual row conductor (2i) of the touch screen (13A) at a relatively slow rate to cause the analog-digital circuitry (15) to generate values of the second digital signal (ΔDATA) which represent a change in the self capacitance (Cselfj) of any column conductor (3j) of the touch screen (13A) that is less than a predetermined threshold value.

In one embodiment, the method includes initiating operation in the element location scanning mode if the change (ΔCselfj) in the self capacitance of any column conductor (3j) exceeds a predetermined touch threshold value.

In one embodiment, method includes operating the element location scanning mode as a full touch screen scanning mode.

In one embodiment, the method includes generating the first digital signal (DATA) during the element location scanning mode as a convoluted signal which is a function of the mutual capacitances (Cmij) of at least a plurality of the row conductors (2i).

In one embodiment, the invention provides a touchscreen controller (36-1) including means (15) for producing a first digital signal (DATA) representative of a self capacitance (Cselfj) of a second type conductor (2j) of a touch screen (13A) during an element proximity scanning mode and also representative of mutual capacitances (Cmij) of the touch screen (13A) during an element location scanning mode; means (39,40) for calibrating the first digital signal (DATA) with respect to base line data representing neutral values of the self capacitances (Cselfj) during the element proximity scanning mode and also calibrating the first digital signal (DATA) with respect to base line data representing neutral values of the mutual capacitances (Cmij) during the element location scanning mode so as to produce a second digital signal (ΔDATA) which may represent either element proximity induced self-capacitance change values (ΔCselfj) during the element proximity scanning mode or element location induced mutual capacitance change values (ΔCmij) during the element location scanning mode; means (80) for operating on the second digital signal (ΔDATA) during the element proximity scanning mode to determine proximity of the element (22) relative to the touch screen (13A); and means (44) for operating on the second digital signal (ΔDATA) during the element location scanning mode to produce a third digital signal (58) which represents a magnitude map of the element location induced mutual capacitance change values (ΔCmij).

### BRIEF DESCRIPTION OF THE DRAWINGS

FIG. 1 is a block diagram of a prior art touch screen controller system, as shown in FIG. 3A of both mentioned Patent Application Publication 20100/0244859.

FIG. 2 is a schematic diagram of prior art analog front end circuitry of the touch screen controller system in FIG. 1.

FIG. 3 is a schematic diagram illustrating the switch configurations during a precharge phase of the circuitry in FIG. 2.

FIG. 4 is a schematic diagram of prior art analog front end circuitry during a measurement phase of the circuitry in FIG. 2.

FIG. 5 is a block diagram that illustrates a low-power, high-speed, high sensitivity touch detection circuitry of the present invention in combination with the touch screen controller system of FIG. 1.

FIG. 6 is a graph which illustrates change in self capacitance indicative of the presence of a finger touch on the touchscreen panel 13A in FIG. 5.

FIG. 7 shows an implementation of touch presence monitor 80 in FIG. 5.

### DETAILED DESCRIPTION OF THE PREFERRED EMBODIMENTS

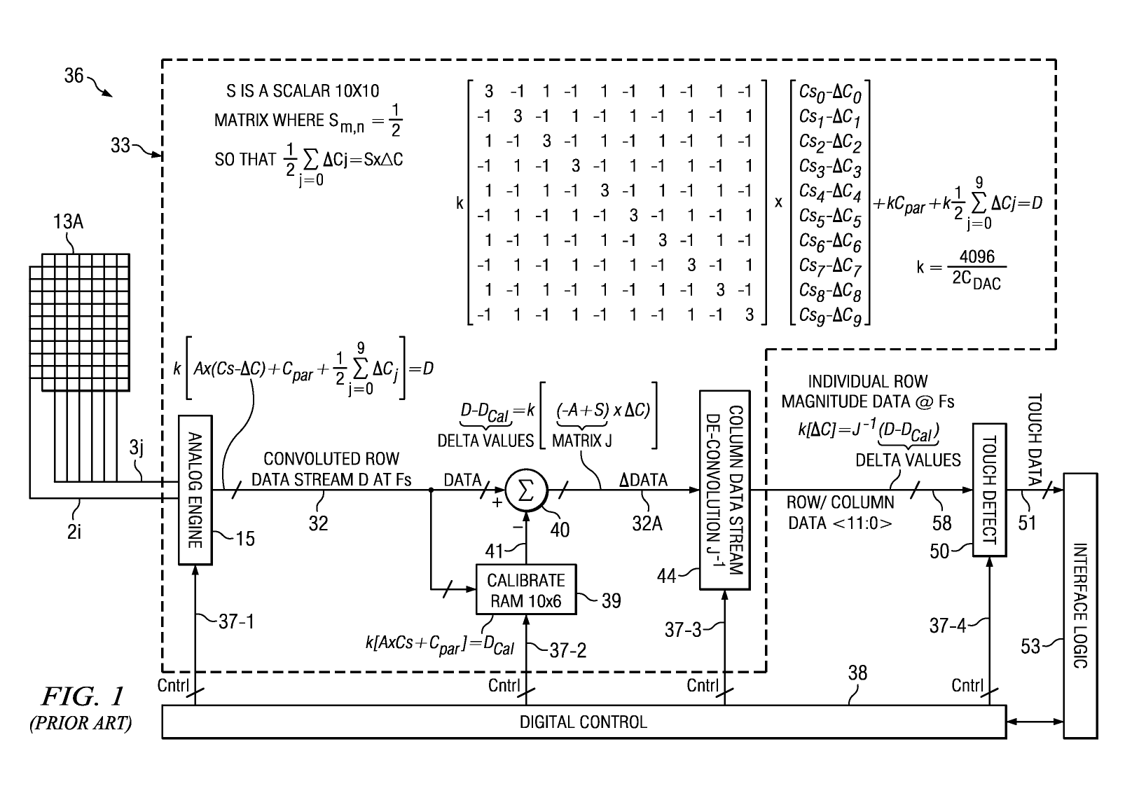

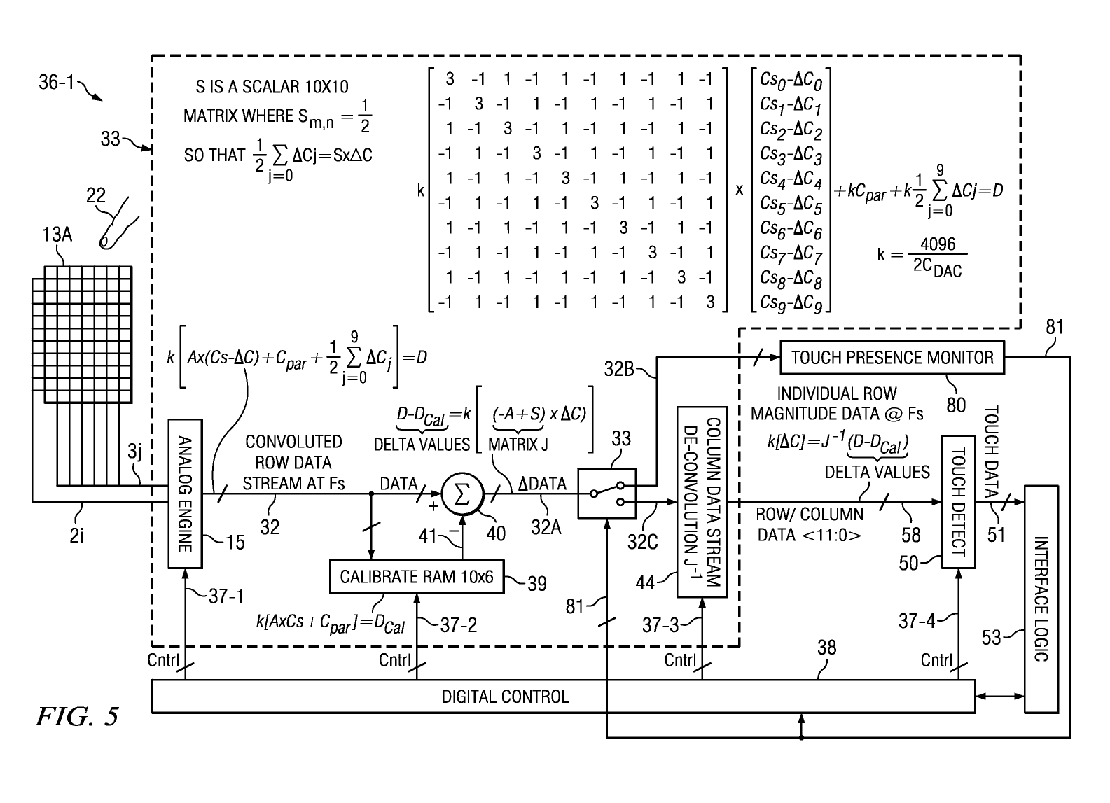

Touch screen controller system 36-1 in FIG. 5 includes everything in Prior Art FIG. 1, and further includes touch presence monitoring circuit 80, which operates during a low-power “touch presence monitoring mode” to detect the presence of a valid touch on touch screen panel 13A. The portions of touch screen controller 36-1 which are substantially the same as the portions shown in Prior Art FIG. 1 operate essentially the same as in prior art touch screen controller 36 of FIG. 1.

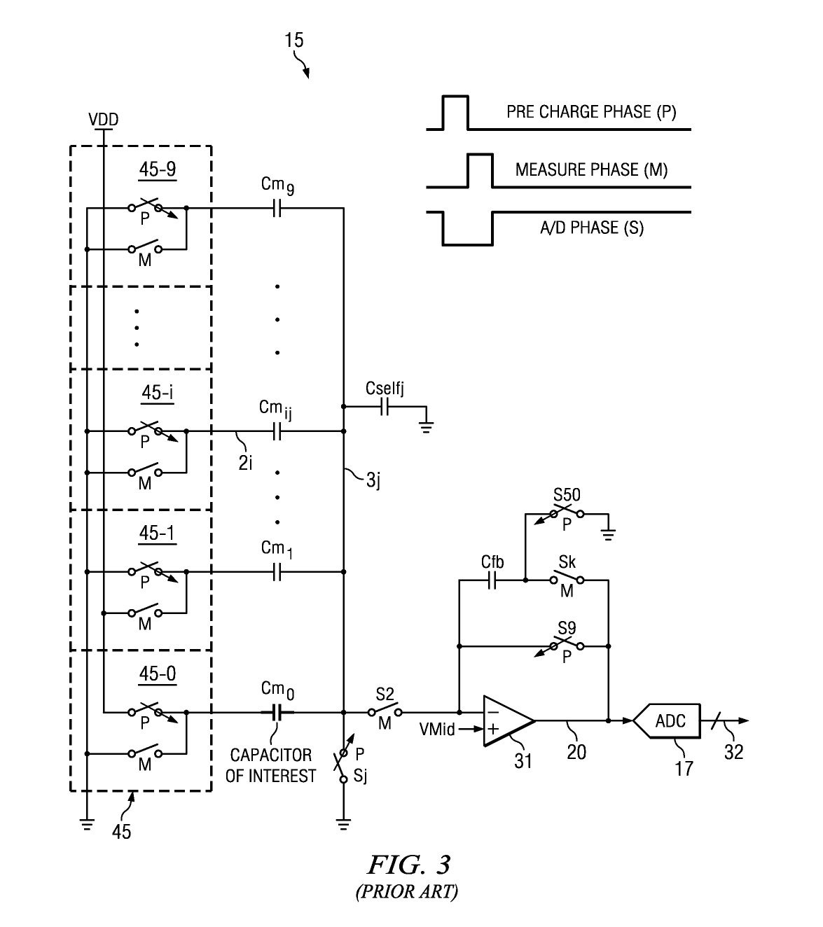

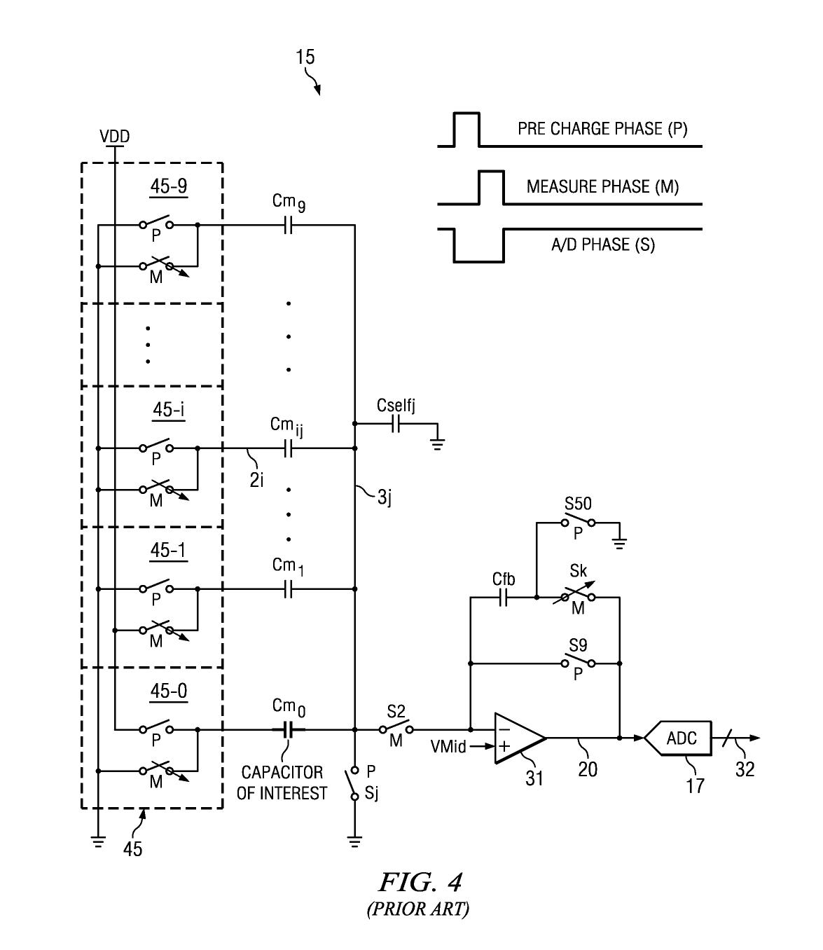

Touch screen controller system 36-1 of FIG. 5 has three main modes of operation, including the foregoing touch presence monitoring mode, the “full panel scanning mode” previously described with respect to Prior Art FIG. 1, and also a “deep sleep” mode. The touch presence monitoring mode is a low-power mode in which an application device (such as a cell phone, computer tablet, remote controller, or other battery-operated device having a touch screen) operates to periodically scan touch screen panel 13A for the presence of a valid finger touch on touch panel 13A. (For example, a low frequency oscillator may be used to periodically switch touch screen controller system 36-1 from its deep sleep mode into its touch presence monitoring mode.) The full panel scanning mode has been previously described with reference to FIGS. 1-4, and is started up whenever a valid touch is detected during the touch presence monitoring mode. In the deep sleep mode, most of the circuitry of touch control system 36-1 is powered down.

Touch presence monitoring circuitry 80 of touch screen controller 36-1 in FIG. 5 includes circuitry that compares the raw data ΔDATA generated by analog engine 15 and algebraic summer 40 acting together to a predetermined touch threshold and uses the comparison result to either cause touch controller 36-1 to be in its low-power touch presence monitoring mode if no valid touch is present or to start the full panel scanning mode previously described. More specifically, after calibrating the 6 voltage values of the 6 column conductors 3j (where 0<j<5) under a “no touch” condition, those 6 calibrated values are subtracted from the column conductor voltages by means of algebraic summer 40 when a valid touch is present. Algebraic summer 40 subtracts the calibration values from the corresponding values of DATA so as to achieve the desired calibration, irrespective of whether touch screen controller is in its touch presence monitoring mode or its full panel scanning mode. The raw data ΔDATA coming out of algebraic summing circuit 40 during the touch presence scanning mode differs from the raw data coming out of analog engine 15 during the touch presence scanning mode in that ΔDATA is normalized to zero for a “no touch” condition. The structure and operation of touch screen presence monitoring circuit 80 are subsequently explained with reference to FIG. 7.

It should be recognized that the calibration values may be different for the full panel scanning mode and the touch presence mode. It is essential to use a 3q charge transfer process for the touch presence monitoring mode, but it is not essential to use a 3q process for the full panel scanning mode. For example, either one of a number of possible 3q or 2q charge transfer processes process may be used during the full panel scanning mode, and different calibration values must be used unless exactly the same 3q charge transfer process is used for both the touch presence monitoring mode and the full panel scanning mode.

The above mentioned predetermined touch threshold is a digital value which is a representation of a quantity, e.g., a voltage wherein that voltage is a representation of an analog input and is converted by CDAC 17 in FIG. 5 to a digital representation of the charges transferred. Various processes such as the above mentioned de-convolution process and associated scaling may be included in the process of converting the digital output of CDAC 17 into a final digital code that represents the minimum change of any mutual capacitance Cmij required for the present touch to be valid.

Thus, the predetermined touch threshold is a digital value that has been set as the minimum change of Cselfj required for a touch to be valid. If that threshold value is matched or exceeded by a calibrated column voltage ΔDATA on bus 32B, a valid touch is deemed by touch presence monitor 80 to be present and this causes touch screen controller 36-1 to go into its full panel scanning mode (which actually is its touch location mode). The valid touch threshold value may be based on various factors such as noise, environmental conditions, or the desire for a predetermined touch detection sensitivity. (A typical suitable value of the predetermined touch threshold value might be the value of roughly 30 LSBs.)

Bus 32A, which is coupled to the output of algebraic summer 40, is coupled to the input port of a switching circuit 33 that functions like a single pole, double throw switch in order to route the information ΔDATA on bus 32A to either (1) the input of touch presence monitor 80 via bus 32B if touch screen controller 36-1 is in its low power touch presence monitoring mode, or (2) the input of de-convolution circuit 44 via bus 32C if touch screen controller 36-1 is in its high power full panel scanning mode.

The output generated on conductor/bus 81 of touch presence monitor 80 is provided as an input to digital control circuit 38 and also as an input to a switch circuit 33 that routes bus 32A to the input of de-convolution module 44 via bus 32C to cause the ΔDATA to be routed into de-convolution module 44 only during the full panel scan mode. Switch circuit 33 is configured so that ΔDATA does not go through the de-convolution process of de-convolution circuit 44 (which is powered down) during touch monitoring mode, and instead is routed via bus 32B to touch presence monitor 80. If a valid touch is detected by touch presence monitor 80, switching circuit 33 switches touchscreen controller 36-1 from touch presence detecting mode into full panel scanning mode. (It should be appreciated that there are number of possibilities for accomplishing the function of switch circuit 33. For example, an interrupt routine request (IRQ) to a system processor could be generated, or a full panel scanning mode operation could be initiated and then an IRQ could be asserted.)

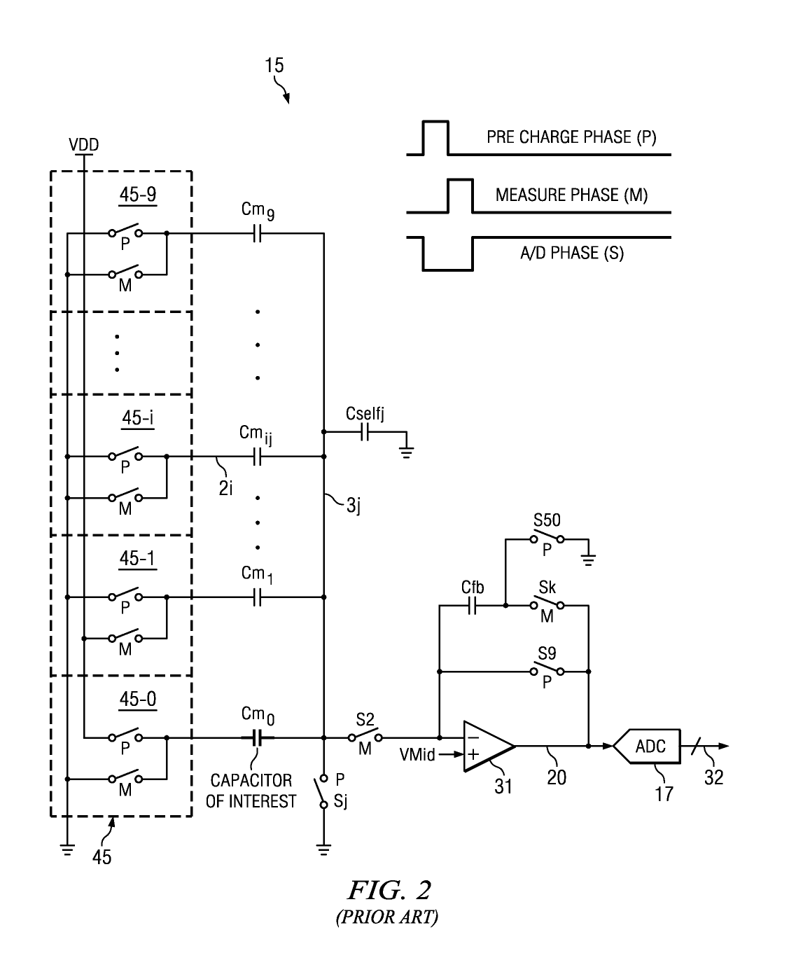

The self capacitance Cselfj of a column conductor 3j (FIG. 2) is its parasitic capacitance. A typical value of self capacitance might be roughly 18 pF (picofarads), depending on the size and type of touch screen panel 13A. The self capacitance Cselfj of each column conductor 3j increases as a finger (or other conductive object) “moves in” to the surface of the touch screen panel 13A because the finger introduces the capacitance of the human body (which may be roughly 50 pF) in parallel with the internal self capacitance Cselfj. (The effect of the finger touch on the mutual capacitance Cmij between a row conductor 2i and a column conductor 3j is much less than the effect on the self capacitance Cselfj of the corresponding column conductor 3j because the finger usually interrupts the electric field between the 2 plates associated with the mutual capacitance and reduces its intensity, depending on how well the person is grounded.) The change ΔCselfj in the self capacitance of any of the 6 column conductors 3j therefore can be directly determined from the output information generated by ADC 17. (As previously indicated in the incorporated-by-reference '859 application, all of the row conductors 2i may be “energized” (e.g., by being switched from one fixed voltage to another to accomplish the charge transfers needed to detect a significant change ΔCmij in the mutual capacitance between a row conductor 2i and a column conductor 3j.

It should be appreciated that there are many different ways of accomplishing such switching, such as the previously mentioned 3q and 2q charge transfer techniques. It also should be appreciated that the operation of touch presence monitoring circuit 80 to determine if a finger touch is present on touch panel 13A is independent of whether the 3q charge transfer method or the previously mentioned 2q charge transfer method (or other method) is utilized for determining the precise touch location.) The effect of the charge transfer on the voltage of each the 6 column conductors 3j is a function of the voltage division between the mutual capacitance Cmij (where 0<i<9) of the corresponding row conductor 2i and the total self capacitance Cselfj, including any change ΔCselfj thereof due to the presence of a finger touch on touch panel 13A, and therefore is a function of charge transfer from each mutual capacitance Cmi onto the column conductor 3j resulting in the total charge transfer across amplifier 31 (FIG. 2) and the feedback capacitor Cfb.

Each touch presence scanning includes determining the amount of any change in the column conductor voltage representative of the self capacitance Cselfj of each column conductor 3j and comparing that voltage change to the above-mentioned predetermined touch threshold voltage. If the difference is greater than the programmed touch threshold level, that means a valid touch has occurred.

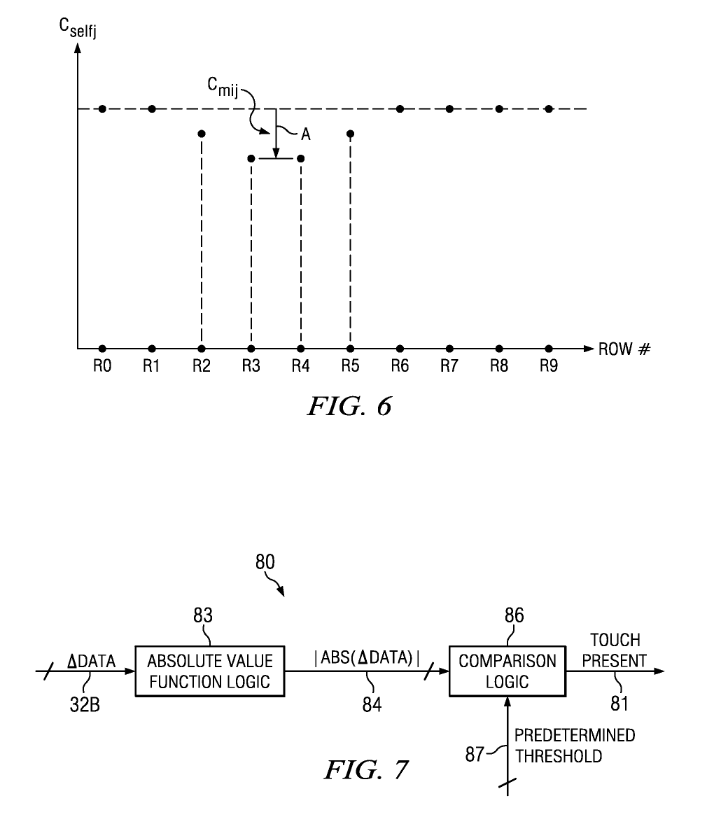

The graph of FIG. 6 indicates 10 measurements of Cselfj indicated by the vertical axis, one for each of rows R0, 1 . . . 9, for any column conductor 3j and subtraction of the calibration values, which are the “non-touch” values of Cselfj measured without performing the de-convolution process. If no valid touch is present, the result is that all of the raw data values ΔDATA are “0”s, as indicated by the data points along the “Row#” axis. The graph of FIG. 6 also shows the results of a valid touch that is present over a particular column conductor 3j. FIG. 6 shows that all of the 10 R0, 1 . . . 9 raw data values along the column conductor 3j increase in response to a valid touch because the self capacitance Cselfj increases very substantially due to the overlying valid finger touch on touch screen panel 13A. The illustration FIG. 6 shows a relatively small decrease “A” in the value of Cselfj over the R3 and R4 data points, caused by the reduction in raw data values of ΔDATA due to reduction in mutual capacitance values Cmij directly under the foregoing valid finger touch on touch screen panel 13A. The other arrow in the graph of FIG. 6 is labeled “Cselfj Increase”.

Normally in the “no touch present” situation, after calibration, after subtracting the non-touch values to get zeros, this shows that Cselfj values increase when a touch occurs. If an entire column conductor is “scanned”, all of the self capacitance values are increased, but there is a relatively small voltage drop where the touch occurs. (It should be appreciated that it does not matter which row is selected to provide the mutual capacitance of interest, and the data related to the value of that mutual capacitance of interest is not utilized in the determination of the change of self capacitance of the selected column conductor 3j.) This example shows that using the 3q charge transfer methodology involves measuring row conductor voltages and column conductor voltages representing both mutual capacitances Cmij and self capacitances Cselfj, due to the resulting capacitive voltage division. Thus, the finger touch indicated in FIG. 6 lies between the dots for rows R3 and R4 of touch screen panel 13A, so energizing either row 3 or 4 in the mutual capacitance effectuates determination of the value of one of those values of Cselfj. However, if no row is energized or driven, all of the Cselfj values will appear on a straight upper line of dots in FIG. 6 and each represents the finger-touch-induced change in Cselfj, and no mutual capacitance-based shift in the value of Cselfj will appear.

Another possible way of obtaining the calibration values of Cselfj would be to measure the values of Cselfj with a valid touch present, followed by removal-induced components of Cselfj would provide the same ΔCselfj values but with the opposite polarity or sign. Basically, the values are the baseline values with no touch present. Note that the de-convolution is used to extract the convolution values, it is not needed to extract the self capacitance values. Because for the self capacitance values, it is going to be the same for every row you energize, with a small amount of noise variation.

Note that in one practical embodiment, analog engine 15 can be configured to either perform a 3q charge transfer operation or a 2q charge transfer operation, depending on the user's preference. The 3q methodology involves grounding the column conductors 3j, and the self capacitance is included in the relevant equations (not shown), whereas the 2q measurement is based only on the mutual capacitance values, and the self capacitance values are not involved in the 2q methodology. In any case, data stream DATA (i.e., D) then is input to algebraic summer 40, which functions to subtract the stored calibration data from DATA on bus 32.

### Touch Presence Detecting/Monitoring Mode

In the touch presence monitoring mode, only a single “3q” charge transfer procedure is performed involving a single mutual capacitance of interest, i.e., for a single row (such as any of rows R0, 1 . . . 9 as indicated in FIG. 6). The resulting raw data for each column conductor 3j is input to calibration RAM circuitry 39. A charge transfer is effectuated using the capacitance of interest with a +3q charge transfer. For the touch presence monitoring mode, only one capacitor of interest is used to generate DATA (i.e., D) on bus 32 and the raw self capacitance data ΔDATA on bus 32A. Essentially, the amount of mutual capacitance Cmi is ignored, and only the self capacitance Cselfj is used to indicate whether or not a valid touch is present.

Referring to FIG. 7, touch presence monitor 80 of FIG. 5 includes a logic circuit 83 which generates the absolute value of signal ΔDATA on bus 32B. (This is necessary because the subtraction which may occur in the generation of ΔDATA may result in negative values, depending on the order in which the subtraction is performed.) The absolute value of ΔDATA generated on bus 84 is applied to a logic circuit 86 which compares the absolute value of ΔDATA to the above mentioned predetermined touch threshold and generates a “1” on conductor 81 to indicate that a touch is present on touch screen 13A if the absolute value of ΔDATA equals or exceeds the predetermined touch threshold. If not, logic circuit 86 generates a “0” on conductor 81. The predetermined touch threshold value may be supplied on bus 87, which may be coupled to a user-programmable register (not shown) or other circuitry that may be included in digital control circuit 38. (It should be understood that the function performed by touch presence monitor 80 may be readily implemented in various other ways.)

Calibration RAM circuitry 39 operates during the touch presence scanning mode to help touch presence monitor 80 determine how a “no touch” condition is defined and to provide a “baseline” against which to compare the convoluted row data stream DATA on bus 32 in order to determine if a valid touch has just occurred. If touch presence monitor 80 determines that the raw value of the ΔDATA on bus 32B representing self capacitance Cselfj of a scanned column conductor 3j has increased significantly, touch presence monitor 80 then generates a “valid touch” signal on bus 81. That causes switching circuit 33 and de-convolution circuit 44 to initiate the high power full panel scanning mode to determine the precise location of the valid touch on touch screen panel 13A, and also to determine when a valid touch is no longer present.

### Full Panel Scanning Mode

After the previously described precharge/measure sequence, the raw data ΔDATA generated by analog engine 15, calibration RAM circuitry 39, and algebraic summer 40 is used to generate both the mutual capacitance values Cmij (i.e. the +3 −1, −1 . . . charge transfer results) and the increase ΔCselfj in the self capacitance of the column conductor 3i. In the presence of a valid touch, all 10 of the 3q charge transfers result in the increases of all 10 self capacitance measurements. (Note that the Cselfj values are ignored for the full panel scanning determinations of touch location.) During the full panel scanning in response to a valid touch, each column is scanned 10 times, and the previously explained matrix math computations are performed. When the present valid touch is removed, touch detect circuit 50 causes touch sensor controller 36-1 to switch from its high power full panel scanning mode back to its low power touch presence monitoring mode.

The resulting responses of all of the 6 column conductors 3j due to the voltage division across the corresponding mutual capacitance Cmij of interest and the self capacitances Cselfj of each column conductor 3j are scanned. This technique of scanning changes in self capacitance Cselfj to detect the presence of a valid touch is substantially different than the conventional technique of detecting the presence of a touch on the basis of the amount of touch-induced change in the mutual capacitance Cmij between a row conductor 2i and a column conductor 3j (as indicated in system 36 of Prior Art FIG. 1). The resulting raw data values D (i.e., DATA on bus 32) generated by ADC 17 (see FIG. 2) of analog engine 15 and the calibrated raw data value ΔDATA on bus 32B are compared with the predetermined touch threshold voltage to determine whether or not the self capacitance Cselfj of any column conductor 3j has increased sufficiently to indicate that a valid finger touch is present on touch screen panel 13A. If that is the case, touch presence monitoring circuit 80 then generates a “touch present” signal on conductor or bus 81. This causes the state machine in digital control circuit 38 to initiate the previously described full panel scanning in order to determine the precise location of the valid touch.

The 10 raw data measurements ΔDATA are processed by the previously described de-convolution matrix array shown in FIG. 5 and generate relatively low values that indicate the location of the peak mutual capacitance (Cmij) values immediately beneath the valid touch. The resulting values show that the change in self capacitance of a column conductor 3j is much more sensitive than the corresponding net increase for the selected column 3j. That is, changes in ΔCselfj are much more sensitive to presence of a valid touch than changes in ΔCmi. The raw data voltage values on column conductor 3j representing Cselfj are sufficiently large that they can be used directly, without further mathematical processing, to determine if the predetermined threshold voltage has been exceeded (so as to indicate the presence of a valid touch on touch screen panel 13A).

Thus, touch sensor controller 36-1 of FIG. 5 detects the presence of a touch anywhere on touch screen panel 13A more quickly and efficiently than the prior art and without performing a high power consuming full panel scanning of all row and column conductors of touch screen panel 13A. The improved touch presence monitoring in touch screen controller 36-1 is based on providing relatively large touch-induced increases ΔCselfj in the amount of self capacitance of a single column conductor 3j due to presence of a finger touch on touch screen panel 13A. The touch-induced increases ΔCselfj are substantially greater in magnitude than touch-induced increases Cmi in mutual capacitance in the touch controller of Prior Art FIG. 1. This is true because the electric field lines associated with a particular mutual capacitance Cmi emanate from the surface of touch screen panel 13A and extend a relatively small distance beyond that surface, and then return to the surface of panel 13A, whereas electrical field lines associated with the self capacitance Cself of a particular column conductor 3j extend much further beyond the surface of touch screen panel 13A. Consequently, a finger touch has much more influence on the self-capacitance Cselfj than on a mutual capacitance Cmi.

Furthermore, since the raw self capacitance data represented by ΔDATA is used directly, without further processing, to detect the presence of a touch element, the required amounts of time and power for detecting the presence of a touch element is substantially reduced.

To summarize, when no valid touch is present on touch screen panel 13A (which ordinarily is most of the time), touch screen controller 36-1 is either in its low-power touch presence monitoring mode or its deep sleep mode. Instead of in effect performing 60 measurements of mutual capacitance in 10 row by 6 column touch screen panel 13A and then performing the previously mentioned matrix mathematics to de-convolute the mutual capacitance data in order to detect the mere presence of a touch, the change in self capacitance of each of the 6 column conductors in effect is measured. The largest resulting self capacitance change CSELFJ of any column conductor 3j is compared to a predetermined touch threshold value to determine if a valid touch is present on touch panel 13A. Since only 6 fast, low-power self capacitance measurements, rather than 60 slow, high power mutual capacitance measurements are required, the total power consumption of touch screen controller 36-1 is very low compared to that of the prior art.

Furthermore, the self capacitance increase due to a valid finger touch typically is roughly 7 or 8 times more sensitive than the mutual capacitance to a finger moving to the touch screen panel surface then the mutual capacitance. The increased sensitivity of using self capacitance for touch detection may have the benefit of allowing convenient detection of large objects, and also has the benefit of improved signal to noise ratios and better noise performance.

While the invention has been described with reference to several particular embodiments thereof, those skilled in the art will be able to make various modifications to the described embodiments of the invention without departing from its true spirit and scope. It is intended that all elements or steps which are insubstantially different from those recited in the claims but perform substantially the same functions, respectively, in substantially the same way to achieve the same result as what is claimed are within the scope of the invention.

As another example, the previously mentioned 2q charge transfer technique can be used for the full panel scanning mode along with using the 3q charge transfer technique for valid touch presence monitoring. But in any case, the 3q charge transfer methodology is the only methodology which, in effect, determines the changes induced in the column conductor self capacitance by the presence of a valid touch.

It should be appreciated that it is not necessary to drive or energize any row during the touch presence monitoring mode, even though it may be more convenient to do so. Although it is necessary to drive or energize one row and sense one column to obtain any mutual capacitance value Cmij in the full panel scanning mode, in the touch presence monitoring mode is only necessary to determine finger-touch-induced changes in self capacitance values Cselfj rather than changes in mutual capacitance Cmij. And of course, the functions of row conductors and column conductors could be easily reversed.

Furthermore, multiple conductors 3j could be connected together to provide, in essence, a relatively large capacitive plate having a large self capacitance for the purpose of, for example, detecting the proximity of relatively large objects with respect to the surface of the touch screen panel. (By way of definition, the term “proximity” herein is intended to refer to either the general or the precise location, relative to a touch screen, of a finger, cheek or other body part, or sufficiently conductive probe or stylus that touches the touch screen surface or is located relatively close to the touch screen surface.)

As yet another example, since ΔCselfj is highly sensitive with respect to a finger touch, the presence or proximity of a cheek or other body part (or other sufficiently conductive element) adjacent to or proximate to the touchscreen may be detected when the cheek or other body part, etc., is within roughly an inch of the touchscreen surface. The same circuitry described above for detecting the presence of a touch on the surface of screen 13A can also be used to detect the “proximity” of a relatively large object or body part relative to screen 13A. The difference between the above described touch presence monitoring and this “proximity detection” of a relatively large object is in the interpretation of ΔDATA. In the case of touch presence monitoring, the presence of a valid touch on screen 13A is detected if the change in self capacitance ΔCselfj of any column 3j exceeds a single predetermined threshold, and if this is true then full panel scanning is initiated. However, in the case of “proximity detection” such as detection of the proximity of a face, cheek, or hand, etc., which is sufficiently close to screen 13A, the above-mentioned single predetermined threshold is not necessarily used. Instead, changes in ΔCselfj of one or more columns are analyzed to determine if the profile of a predetermined pattern of ΔCselfj values represents a suitable “proximity” of a face, cheek, hand, etc., that is acceptably close to screen 13A to indicate its being “proximate” thereto. If that turns out to be the case, then a suitable “proximity” signal is generated and utilized to trigger a particular desired result. (Hysteresis may be introduced to maintain the status of the proximity detection of a face or other large object if, for example, the face or other object moves away and a finger touches screen 13A. Generally, the presence of a predetermined profile of relatively large ΔCselfj values is interpreted to indicate proximity of a face, hand, etc., to screen 13A. In some cases, multiple columns can be connected together for this purpose to provide increased sensitivity of the ΔCselfj values to the proximity of a face, hand, etc.

Furthermore, although the described embodiment of the invention includes only a single analog engine, a separate analog engine could be provided for each column conductor 3j, respectively, to provide faster operation in both the full panel scanning mode and the valid touch detection mode.

As another example, touch presence monitor 80 may continue to monitor ΔDATA even during a full panel scanning operation in order to more quickly detect a no-touch condition to thereby allow powering down of the full scanning mode as soon as possible to minimize power consumption.

What is claimed is:

1. A touch screen controller system for controlling a touch screen having a first number of first type conductors and a second number of second type conductors, comprising:
(a) analog-digital circuitry coupled to the first type conductors and the second type conductors of a touch screen for producing a first digital signal representative of a self capacitance of one of the second type conductors during an element proximity scanning mode and also representative of mutual capacitances of the touch screen during an element location scanning mode, the analog-digital circuitry operating to superimpose charge transfers from mutual capacitances of one of the first type conductors to one of the second type conductors during the element location scanning mode, and also operating to produce information representative of the influence of an element on the self-capacitance during the element proximity scanning mode;
(b) calibration circuitry coupled to receive the first digital signal for calibrating the first digital signal with respect to base line data representing neutral values of the self capacitances during the element proximity scanning mode and for calibrating the first digital signal with respect to base line data representing neutral values of the mutual capacitances during the element location scanning mode to produce a second digital signal which may represent either element proximity induced self-capacitance change values during the element proximity scanning mode or element location induced mutual capacitance change values during the element location scanning mode;
(c) touch presence monitoring circuitry for operating on the second digital signal during the element proximity scanning mode to determine if the element is proximate to the touch screen; and
(d) a processing circuit for operating on the second digital signal during the element location scanning mode to produce a third digital signal which represents a magnitude map of element induced mutual capacitance change values.

2. The touch screen controller system of claim 1 wherein the first type conductors are row conductors and the second type conductors are column conductors.

3. The touch screen controller system of claim 2 wherein the touch presence monitoring circuitry operates to continue the element proximity scanning mode by causing the analog-digital circuitry to repeatedly energize an individual row conductor to cause the analog-digital circuitry to generate values of the second digital signal which represent a change in the self capacitance of any column conductor that is less than a predetermined touch threshold value.

4. The touch screen controller system of claim 2 wherein if the change in the self capacitance of any column conductor exceeds a predetermined touch threshold value, then the touch presence monitoring circuitry operates to switch operation of the analog-digital circuitry to the element location scanning mode.

5. The touch screen controller system of claim 2 wherein the element location scanning mode is a full touch screen scanning mode.

6. The touch screen controller system of claim 2 wherein the element is a human finger touching a surface of the touch screen.

7. The touch screen controller system of claim 2 wherein the element is a human body part located proximate to a surface of the touch screen.

8. The touch screen controller system of claim 2 wherein the calibration circuitry includes a calibration memory for storing the base line data and an algebraic summer for subtracting the base line data from the first digital signal.

9. The touch screen controller system of claim 2 wherein the analog-digital circuitry includes an analog-to-digital converter which generates the first digital signal.

10. The touch screen controller system of claim 2 including a touch detection circuit coupled to receive the third digital signal, for repeatedly detecting and storing updated values of a first maximum magnitude capacitance variable and associated row and column locations to determine the location of a maximum magnitude mutual capacitance change caused by a present touch on the touch screen.

11. The touch screen controller system of claim 4 wherein during the element location scanning mode the analog-digital circuitry causes the first digital signal to be a convoluted signal which is a function of the mutual capacitances of at least a plurality of the row conductors.

12. The touch screen controller system of claim 11 wherein the processing circuit includes a de-convolution circuit which operates on the second digital signal by solving a plurality of equations that represent the mutual capacitances as functions of the amounts and polarities of charge transferred to a first column conductor and corresponding voltage components produced on the first column conductor in order to produce the third digital signal.

13. The touch screen controller system of claim 12 wherein the de-convolution circuit stores an inverse matrix representing coefficients of a plurality of equations that represent the mutual capacitances as functions of the amounts and polarities of charge transferred to the first column conductor and the corresponding voltage components produced on the first column conductor, and multiplies the inverse matrix by a vector matrix representing values of the second digital data signal obtained for each of the mutual capacitances to obtain the values of the third digital signal representing the magnitude map of the touch capacitance change values.

14. The touch screen controller system of claim 11 wherein the analog-digital circuitry operates to superimpose charge transfers from mutual capacitances of at least the plurality of the row conductors to a second column conductor to cause a corresponding portion of the first digital signal to be a convoluted signal which is a function of the mutual capacitances of at least the plurality of row conductors.

15. The touch screen controller system of claim 2 wherein the touch screen panel includes 10 rows and 6 columns.

16. A method for operating a touchscreen controller, the method comprising:
(a) producing a first digital signal representative of a self capacitance of a second type conductor of a touch screen during an element proximity scanning mode and also representative of mutual capacitances of the touch screen during an element location scanning mode;
(b) calibrating the first digital signal with respect to base line data representing neutral values of the self capacitances during the element proximity scanning mode and also calibrating the first digital signal with respect to base line data representing neutral values of the mutual capacitances during the element location scanning mode so as to produce a second digital signal which may represent either element proximity induced self-capacitance change values during the element proximity scanning mode or element location induced mutual capacitance change values during the element location scanning mode;
(c) operating on the second digital signal during the element proximity scanning mode to determine proximity of the element relative to the touch screen; and
(d) operating on the second digital signal during the element location scanning mode to produce a third digital signal which represents a magnitude map of the element location induced mutual capacitance change values.

17. The method of claim 15 including continuing to operate in the element proximity scanning mode by causing analog-digital circuitry to repeatedly energize an individual row conductor of the touch screen at a relatively slow rate to cause the analog-digital circuitry to generate values of the second digital signal which represent a change in the self capacitance of any column conductor of the touch screen that is less than a predetermined threshold value.

18. The method of claim 16 including initiating operation in the element location scanning mode if the change in the self capacitance of any column conductor exceeds a predetermined touch threshold value.

19. The method of claim 16 wherein the element location scanning mode is a full touch screen scanning mode.

20. The method of claim 16 including generating the first digital signal during the element location scanning mode as a convoluted signal which is a function of the mutual capacitances of at least a plurality of the row conductors.

21. A touchscreen controller comprising:
(a) means for producing a first digital signal representative of a self capacitance of a second type conductor of a touch screen during an element proximity scanning mode and also representative of mutual capacitances of the touch screen during an element location scanning mode;
(b) means for calibrating the first digital signal with respect to base line data representing neutral values of the self capacitances during the element proximity scanning mode and also calibrating the first digital signal with respect to base line data representing neutral values of the mutual capacitances during the element location scanning mode so as to produce a second digital signal which may represent either element proximity induced self-capacitance change values during the element proximity scanning mode or element location induced mutual capacitance change values during the element location scanning mode;
(c) means for operating on the second digital signal during the element proximity scanning mode to determine proximity of the element relative to the touch screen; and
(d) means for operating on the second digital signal during the element location scanning mode to produce a third digital signal which represents a magnitude map of the element location induced mutual capacitance change values.
